(19) United States
(12) Patent Application Publication
(10) Pub. No.: US 2022/0348774 A1
(43) Pub. Date: Nov. 3, 2022

(54) PROCESS OF PREPARING A STRUCTURAL COLORED COATING FILM AND ITS ARTICLES

(71) Applicant: BASF Coatings GmbH, Münster (DE)

(72) Inventors: Xi Lin, Shanghai (CN); Chrstian Gerhard Schaefer, Shanghai (CN); Jianping Ge, Shanghai (CN); Chuan Wang, Shanghai (CN)

(21) Appl. No.: 17/634,070

(22) PCT Filed: Aug. 17, 2020
(86) PCT No.: PCT/EP2020/072955

§ 371 Date: Feb. 9, 2022

(30) Foreign Application Priority Data
Aug. 19, 2019 (CN) PCT/CN2019/101378

(51) Int. Cl. C09D 5/36; C09D 7/20; C09D 7/61; C09D 5/02; C08K 3/36; C08K 7/18

(52) U.S. Cl. CPC C09D 5/36; C09D 7/20; C09D 7/61; C09D 5/022; C08K 3/36; C08K 7/18

(57) ABSTRACT

Described herein is a process of preparing a structural colored coating film including steps of i) applying colloidal particles dispersed in a solvent mixture including at least two organic solvents onto a substrate to form a colloidal particles layer; ii) drying the colloidal particles layer to form a photonic crystal structure layer; iii) applying a coating composition including at least one thermally crosslinkable resin and at least one crosslinking agent onto the photonic crystal structure layer to form a coating; and iv) heat curing. Also described herein is an article having at least one structural colored coating film obtainable or obtained from the process.

### FIELD OF INVENTION

The present invention relates to a process of preparing a structural colored coating film with colloidal particles as well as obtained articles.

### BACKGROUND OF THE INVENTION

In recent years, structural color based photonic crystal structure as a new coloring technology has attracted more and more attention since it provides various brilliant, bright and vivid colors and its preparation process is friendly to the environment. Such structure is produced by self-assembly of colloidal particles on a substrate. When the colloidal particles are orderly placed, the photonic crystal structure shows iridescent colors. The self-assembled structures are quite fragile because the force between particles is comparably weak such as Van der Waals force and hydrogen bonding force. Without chemical bonds between particles, such structures can be easily disassembled in water or solvents.

Several approaches have been developed to improve the mechanical stability of the photonic crystal structure. One approach is to modify colloidal particles by adding curable materials into the interstices of the particles and curing the material by UV and/or thermal, as described in, for example, the paper “Current Status and Future Developments in Preparation and Application of Colloidal Crystals”, Cong H, Yu B, et al, Chem. Soc. Rev., 2013, 42, 7774-7800 and CN109031476A.

Another approach is to use polymeric particles with core-shell structures, as described in, for example, EP2108496A. The cores of the polymeric particles are hard and tend to self-assemble. The shells of the polymeric particles have a glass transition temperature Tg lower than that of the cores and tend to form the matrix of the self-assembled core particles.

A further approach is to fill the interstices of the particles with a polymeric adhesive, for example, with polyacrylate as described in the paper “Rapid Fabrication of Robust, Washable, Self-Healing Superhydrophobic Fabrics with Non-Iridescent Structural Color by Facile Spray Coating”, Zeng Q, Ding C, et al, RSC Adv., 2017, 7, 8443-8452. The adhesive is used to fix the particles in situ and on the surface of the substrate.

Structural color is potentially applicable in various fields such as optical filters, display devices, colorimetric sensors, paints and textile coloration etc. However, structural color as a coating film is limited in use since big challenges exist to prepare a stable structural colored coating film having desired chromaticity and color saturation in a large scale.

CN101260194A disclosed a method of preparing polymer colloid photonic crystal film by spray coating that makes it possible to prepare a structural colored coating film on a large scale.

CN107538945A disclosed a method of preparing homogeneous photonic crystal coating by spray coating, blading or inkjet printing, wherein a solvent having a high boiling point and a solvent having a low boiling point was mixed to use as the solvent of the colloidal particles. The solvent having high boiling point is at least one selected from ethylene glycol, diethylene glycol, formamide and acetamide. The solvent having a low boiling point is at least one selected from water, ethanol and methanol. It was stated that the process can avoid the inhomogeneous distribution of particles i.e. the so-called “coffee-ring” problem.

Therefore, it is still required to provide a process of preparing a stable structural colored coating film with desirable chromaticity, color saturation, and angle-dependent color as well as the obtained articles.

### SUMMARY OF THE INVENTION

In one aspect, the present invention disclosed a process of preparing a structural colored coating film, comprising steps of:

i). applying colloidal particles dispersed in a solvent mixture comprising at least two organic solvents onto a substrate to form a colloidal particles layer;
ii). drying the colloidal particles layer to form a photonic crystal structure layer;
iii). applying a coating composition comprising at least one thermally crosslinkable resin and at least one crosslinking agent onto the photonic crystal structure layer to form a coating; and
iv). heat curing.

In one embodiment of the process according to the first aspect of the present invention, the solvent mixture comprises at least one organic solvent having a high boiling point and at least one organic solvent having a low boiling point.

In another embodiment of the process according to the first aspect of the present invention, the organic solvent having a high boiling point is at least one selected from the group consisting of glycerol, n-butanol, 1,5-pentanediol and propylene carbonate, and the organic solvent having a low boiling point is at least one selected from the group consisting of ethanol, acetone and isopropanol.

In another embodiment of the process according to the first aspect of the present invention, the solvent mixture comprises ethanol and at least one selected from the group consisting of glycerol, n-butanol, 1,5-pentanediol and propylene carbonate.

In another aspect, the present invention disclosed an article having a structural colored coating film obtained from the invented process of preparing a structural colored coating film.

### DETAILED DESCRIPTION OF THE DRAWINGS

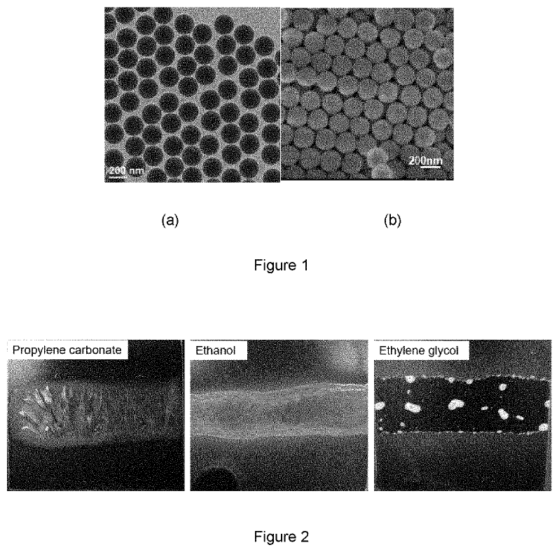

FIGS. 1 (a) and (b) respectively show a transmission electron micrography (TEM) image and a scanning electron micrography (SEM) image of the silica colloidal particles prepared by the invented process.

FIG. 2 shows digital photo images of the photonic crystal structure in Comparative Example 1.1, 1.2 and 1.3.

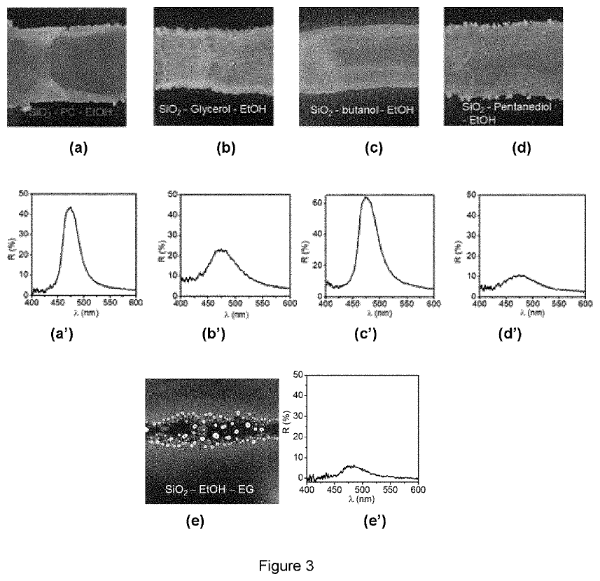

FIGS. 3 (a), (a′), (b), (b′), (c), (c′), (d), (d′), (e) and (e′) respectively show a digital photo image and a graph of reflection spectra of the photonic crystal structure obtained in Example 1.1, 1.2, 1.3, 1.4 and Comparative Example 1.4.

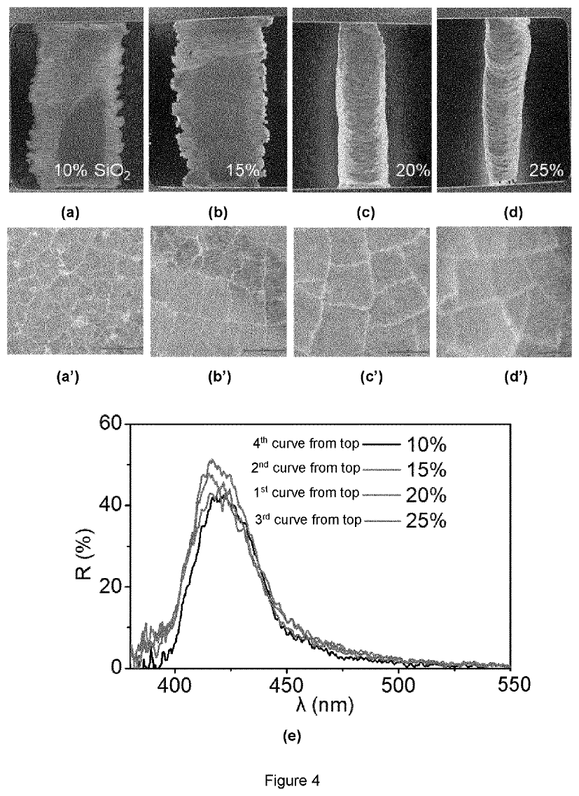

FIGS. 4 (a), (a′), (b), (b′), (c), (c′), (d) and (d′) respectively show a digital photo image and an optical microscopy image of the photonic crystal structure obtained in Comparative Example 2.1, Example 2.1, Example 2.2 and Comparative Example 2.2. FIG. 4 (e) shows graphs of reflection spectra of the photonic crystal structure obtained in Examples 2.1, 2.2 and in Comparative Examples 2.1, 2.2, wherein the sequence number of curves is given according to the peak height of each curve (from the highest to the lowest).

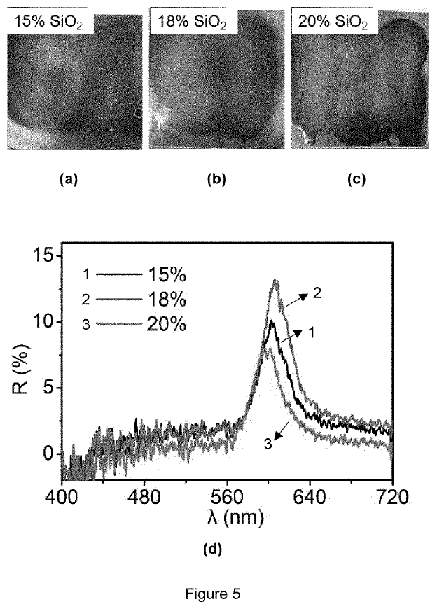

FIGS. 5 (a) to (c) show digital photo images of the structural colored coating films obtained in Example 3. FIG. 5 (d) shows graphs of reflection spectra of the structural colored coating films obtained in Example 3.

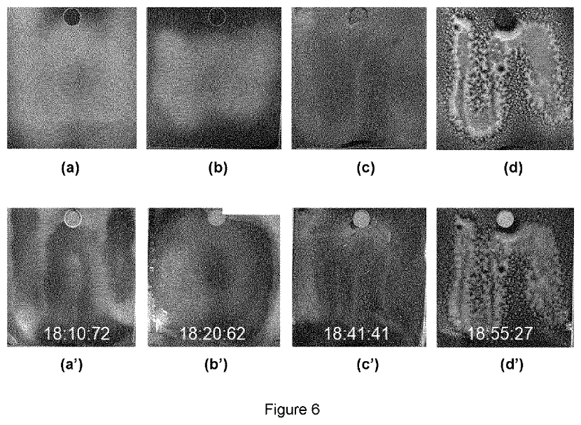

FIGS. 6 (a) to (d) show digital photo images of SiO₂ photonic crystal structure layers obtained in Example 4 before applying the coating composition comprising at least one thermally crosslinkable resin and at least one crosslinking agent. FIGS. 6 (a′) to (d′) show digital photo images of the final structural colored coating films obtained in Example 4, wherein the numbers in each image represents the volume ratio of SiO₂, propylene carbonate and ethanol.

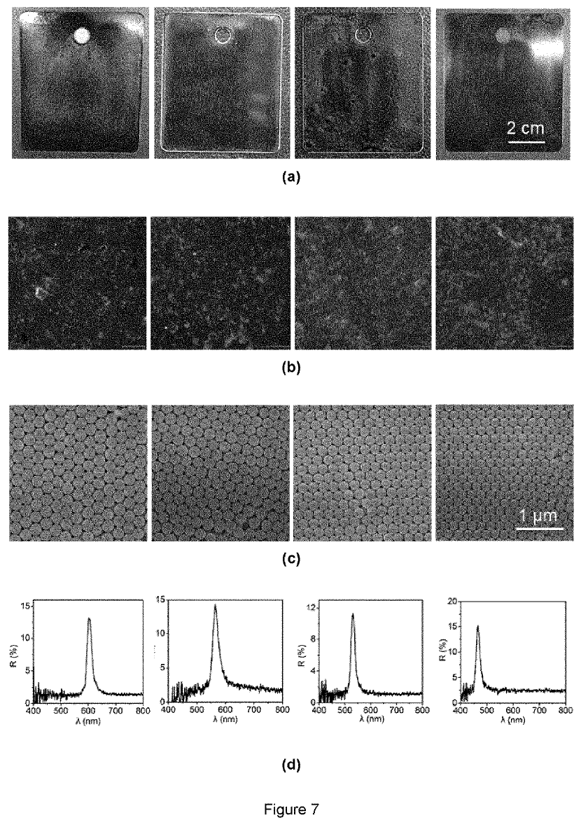

FIG. 7 (a) shows the red, yellowish, green and blue structural colored coating films obtained in Example 5 containing silica particles having sizes of 251 nm, 242 nm, 218 nm and 192 nm respectively (from left to right). FIG. 7 (b) shows optical microscope images of the red, yellowish, green and blue structural colored coating films obtained in Example 5 containing silica particles having sizes of 251 nm, 242 nm, 218 nm and 192 nm respectively (from left to right). FIG. 7 (c) shows scanning electron micrography (SEM) images of the red, yellowish, green and blue structural colored coating films obtained in Example 5 containing silica particles having sizes of 251 nm, 242 nm, 218 nm and 192 nm respectively (from left to right). FIG. 7 (d) shows graphs of reflection spectra of the red, yellowish, green and blue structural colored coating films of obtained in Example 5 containing silica particles having sizes of 251 nm, 242 nm, 218 nm and 192 nm respectively (from left to right).

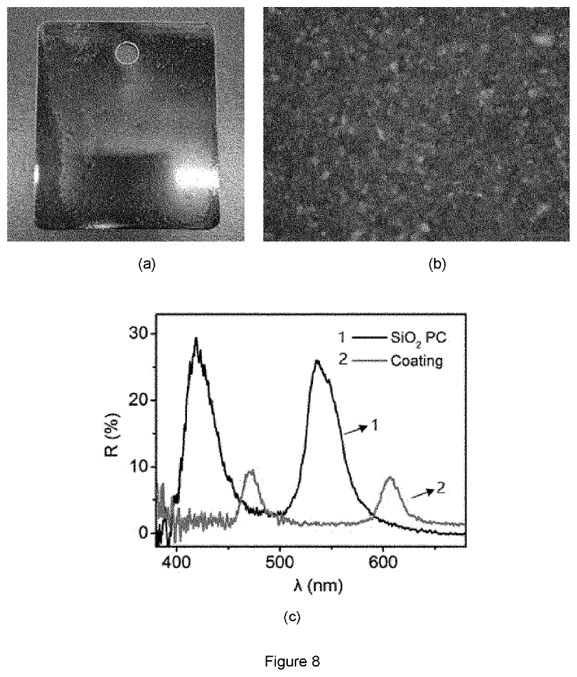

FIGS. 8 (a) and (b) respectively show a digital photo image (left) and an optical microscopy image (right) of the purple structural colored coating film obtained in Example 6. FIG. 8 (c) shows graphs of reflection spectra of SiO₂ photonic crystal structure layer and the final structural colored coating film obtained in Example 6.

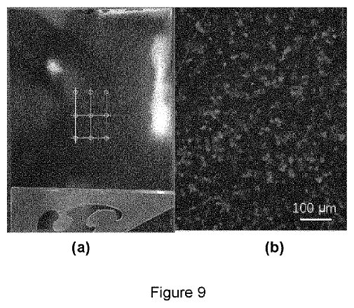

FIGS. 9 (a) and (b) respectively show an optical image (left) and an optical microscopy image (right) of the structural colored coating film on a plane substrate in a size of 21 cm×29.7 cm obtained in Example 7.

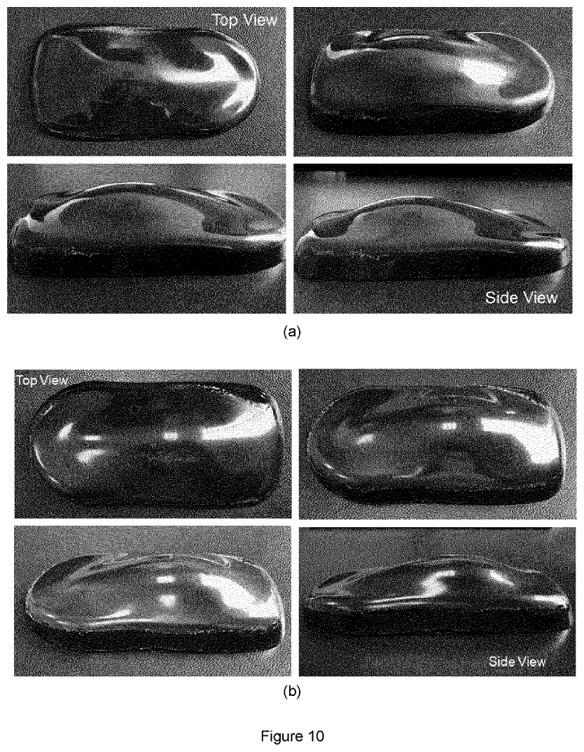

FIG. 10 (a) shows digital photo images of the structural colored coating film on stereo substrates obtained in Example 8 that presents angle-dependent colors i.e. yellowish green from the top and greenish blue from the side. FIG. 10 (b) shows digital photo images of the structural colored coating film on stereo substrates obtained in Example 9 that presents angle-dependent colors i.e. red from top and green from the side.

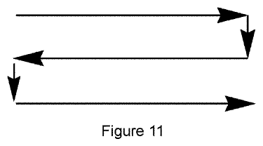

FIG. 11 shows a schematic path of zigzag spray coating.

### DETAILED DESCRIPTION OF THE INVENTION

It is understood that the present invention could be embodied in various ways and shall not be limited to the embodiments set forth herein. Unless clearly dictated otherwise, all technical and scientific terms used here have common meanings recognized by any person skilled in the art. Within the context, the singular forms “a”, “an”, and “the” include plural referents unless the context clearly dictates otherwise.

The term “the process according to the present invention” refers to the invented process of preparing a structural colored coating film.

The term “colloidal particles” refers to inorganic and/or polymeric colloidal particles. The term “article” refers to the product obtained from the process according to the present invention on which a structural colored coating film is applied.

The term “substrate” refers to any objects having a surface on which a suspension of colloidal particles will be applied to form a photonic crystal structure layer. The substrate could be coated with one or more layers of colloidal particles.

The term “thermally crosslinkable resin” refers to any resin having at least one functional group reactive to any crosslinking agent by heating optionally in presence of a catalyst.

The term “high boiling point” refers to a boiling point no less than 110° C. under 101.325 KPa.

The term “low boiling point” refers to a boiling point less than 100° C. under 101.325 KPa.

According to the first aspect of the present invention, the process of preparing a structural colored coating film comprises steps of

i). applying colloidal particles suspending in a mixture comprising at least two organic solvents onto a substrate to form a colloidal particles layer;
ii). drying the colloidal particles layer to form a photonic crystal structure layer;
iii). applying a coating composition comprising at least one thermally crosslinkable resin and at least one crosslinking agent onto the photonic crystal structure layer to form a coating; and
iv). heat curing.

In the process according to the present invention, the substrate is either metallic material or nonmetallic material such as plastic. Examples of metallic materials include iron, aluminum, brass, copper, tin, stainless steel, galvanized steel, plated steels etc. Examples of plastic materials include polyethylene, polypropylene, acrylonitrile-butadiene-styrene (ABS), polyamide, acrylic, vinylidene chloride, polycarbonate, polyurethane, epoxy resins and fiber-reinforced plastics.

The substrate is either planar or stereo for the application of colloidal particles suspensions. The color of substrate surface is determined by the desired color effect of the article. In some embodiments, the surface of substrate is black.

In some embodiments of the process according to the present invention, the substrates are exterior panel or other parts of automobiles such as passenger cars, tracks, motorcycles and buses. Optionally, the surfaces of the metallic substrates are applied with surface treatment such as phosphate treatment, chromate treatment and composite oxide treatment. Optionally, the substrates are applied with an electrocoat, a primer and/or a basecoat.

In the process according to the present invention, the colloidal particles are monodisperse inorganic and/or polymeric particles. Examples of monodisperse inorganic particles are particles of silica, titania, zirconium dioxide, zinc oxide, zinc sulphide, zinc selenide, cadmium sulphide, gold, silver, and palladium. The inorganic particles are either spherical or nonspherical that are prepared via known methods, for example modified Stoeber method described in Cong H, Yu B, et al, “Current Status and Future Developments in Preparation and Application of Colloidal Crystals”, Chem. Soc. Rev., 2013, 42, 7774-7800.

Examples of monodisperse polymeric particles are substituted or unsubstituted polystyrene, poly(meth)acrylate, poly(meth)acrylamide, polyvinylacetate, polyethylene, polyvinyl chloride, polypropylene, polylactide and its derivatives, poly(meth)acrylonitrile, polyurethane and their copolymers thereof. Preferably monodisperse polymeric particles are at least one selected from the group consisting of polyacrylic acid, polymethacrylic acid, polyethylene, polypropylene, polylactic acid, polyacrylonitrile, polybutylacrylate, polymethylmethacrylate, polyethylmethacrylate, polyn-butyl methacrylate, polystyrene, polychlorostyrene, polya-methylstyrene, polystyrene/butadiene, polyN-hydroxymethylacrylamide, polystyrene-methyl methacrylate, polyhydroxyacrylate, polyaminoacrylate, polycyanoacrylate, polyfluoromethylmethacrylate, polymethylmethacrylate-butylacrylate, polymethylmethacrylate-ethylacrylate, polystyrene-methyl methacrylate, polyurethanes and their derivatives thereof. The monodisperse polymeric particles are prepared by any known method of emulsion polymerization, dispersion polymerization, solution polymerization and suspension polymerization.

In some embodiments, monodisperse polymeric particles have core-shell structures. Preferably, such polymeric particles are obtainable from copolymerization of at least one hydrophobic monomer and at least one hydrophilic monomer using known methods, for example, the approach described in Zhang Y, et al., Fabrication of functional colloidal photonic crystals based on well-designed latex particles, section 2.1, Journal of Materials Chemistry, 2011, 5, and CN101260194A.

The colloidal particles have a particle size of from 150 nm to 400 nm, preferably from 160 nm to 350 nm, more preferably 170 nm to 300 nm, even more preferably from 180 nm to 270 nm and most preferably from 190 nm to 255 nm.

The inorganic or polymeric particles are dispersed in a solvent mixture to form a suspension of colloidal particles. The solvent mixture comprises at least one solvent having a high boiling point and at least one solvent having a low boiling point.

The ratio by volume between the solvent having a high boiling point and the solvent having a low boiling point is preferably from 1:10 to 10:1, more preferably from 1:3 to 3:1, even more preferably 2:3 to 3:2.

Preferably, the solvent having a high boiling point is selected from the group consisting of glycerol, n-butanol, 1,5-pentanediol and propylene carbonate, and the solvent having a low boiling point is selected from the group consisting of ethanol, acetone and isopropanol.

In some embodiments, the solvent mixture comprises ethanol and at least one selected from the group consisting of glycerol, n-butanol, 1,5-pentanediol and propylene carbonate.

The volume ratio of inorganic or polymeric particles in the suspension is preferably from 10% and to 25%, more preferably from 12% to 23% and even more preferably from 15% to 20% based on the total volume of the suspension of colloidal particles.

The suspension of colloidal particles is applied onto the substrates by using any known method, for example, air spray coating, airless spray coating, electrostatic spray coating, rotary atomization coating, spin coating and roll coating. The coating layer is dried to form a photonic crystal structure layer on the surface(s) of the substrate. The drying step is carried out at a temperature from 15° C. to 160° C., preferably from 45° C. to 130° C., more preferably from 50° C. to 110° C. and most preferably from 55° C. to 90° C.

In some embodiments, at least two photonic crystal structure layers are formed before applying a coating composition comprising a thermally crosslinkable resin and a crosslinking agent. The suspension of colloidal particles for forming several photonic crystal structure layers are the same or different from each other. When one type of suspension of colloidal particles is used to form two or more photonic crystal structure layers, the color saturation is improved. while when more than one type of suspensions of colloidal particles are used to form two or more photonic crystal structure layers, color effect emerges. For example, when two or more suspensions of colloidal particles having different particle sizes are used, a mixed color layer is produced. The colloidal particle suspensions are applied to substrates to form multiple layers. In one embodiment, the multiple layers are dried together. And in another embodiment, the above layer is coated after the underneath layer is dried. After the multiple layers are dried, the coating composition comprising at least one thermally crosslinkable resin and at least one crosslinking agent is applied onto the outmost layer of said multiple layers.

Hereinafter, the coating composition comprising at least one thermally crosslinkable resin and at least one crosslinking agent is alternatively named as “thermally curable coating composition”.

The thermally curable coating composition is either organic solvent based or water based.

Preferably, the thermally crosslinkable resinshave at least one thermally crosslinkable functional group selected from the group of carboxyl, hydroxyl, vinyl, epoxy and/or silanol groups. Examples of the thermally crosslinkable resin are acrylic resins, polyester resins, alkyd resins, urethane resins, epoxy resins, and fluororesins.

Examples of the crosslinking agents are blocked and unblocked polyisocyanate, melamine resins, urea resins, carboxyl-functional compounds, vinyl-functional compounds and epoxy-functional compounds.

Examples of combinations of thermally crosslinkable resin and crosslinking agent are a combination of carboxyl-functional resin and epoxy-functional resin, a combination of hydroxyl-functional resin and polyisocyanate compound, a combination of hydroxyl-functional resin and blocked polyisocyanate compound and a combination of hydroxyl-functional resin and melamine resin and preferably, a combination of hydroxy-functional acrylic resin and melamine-formaldehyde resin, a combination of hydroxyl-functional acrylic resin and polyisocyanate compound, a combination of hydroxyl-functional acrylic resin and blocked polyisocyanate compound, a combination of hydroxyl-functional polyester resin and melamine-formaldehyde resin, a combination of hydroxyl-functional polyester resin and polyisocyanate compound, a combination of hydroxyl-functional polyester resin and blocked polyisocyanate compound, a combination of hydroxyl-functional alkyd resin and melamine-formaldehyde resin, a combination of hydroxyl-functional alkyd resin and polyisocyanate compound, a combination of hydroxyl-functional alkyd resin and blocked polyisocyanate compound, a combination of hydroxyl-functional urethane resin and melamine-formaldehyde resin, a combination of hydroxyl-functional urethane resin and polyisocyanate compound, a combination of hydroxyl-functional urethane resin and blocked polyisocyanate compound, and their mixture thereof.

The thermally curable coating composition further comprises UV absorbers, light stabilizers, antifoaming agents, thickeners, anti-corrosion agents, surface control agents etc. Optionally, the thermally curable coating composition further comprises pigments, dyes etc. in amounts that brings little negative influence on the color of structural colored coating film.

The thermally curable coating composition is either one-pack or multi-pack.

In some embodiments, the substrate is used for automobile bodies or parts and the thermally curable coating composition is any automobile clearcoat formulation.

Preferably, the thermally curable coating composition comprises from 30% to 40% by weight of thermally crosslinkable resin, from 15% to 30% by weight of crosslinking agent, from 35% to 50% by weight of solvent and optionally from 4% to 8% by weight of additives.

In one embodiment, the thermally curable coating composition comprises from 30% to 40% by weight of hydroxyl-functional acrylic resin, from 15% to 30% by weight of polyisocyanate, from 35% to 50% by weight of solvent and optionally from 4% to 8% by weight of additives.

The thermally curable coating composition is applied onto the photonic crystal structure layer by using known methods, for example, spray coating such as air spray coating, airless spray coating and rotary atomization coating.

The thermally curing of the thermal curable coating composition is carried out by known methods such as hot-air heating, infrared heating or high-frequency heating, at a temperature from 60° C. to 200 for from 15 to 60 minutes. The curing temperature varies depending on the substrate material and the thermally curable coating composition. For plastic substrate, the curing temperature is preferably from 60 to 90° C.

Optionally, the process according to the present invention comprises further steps of forming an additional coating layer onto the thermally curable coating layer or any other desired aftertreatment depending on various applications of the articles.

In the second aspect, the present invention provides an article having a structural colored coating film obtainable or obtained from the process according to the present invention. In some embodiments, the article is exterior panel or parts of automobiles such as passenger cars, tracks, motorcycles and buses.

The present invention is further described by Examples that are not intended to limit the scope of the present invention.

### EXAMPLE

Following devices are used to obtain the digital photo images, optional images, optional microscopy images and reflection spectra for the specimens prepared in Examples and Comparative Examples:

(1) Digital Photo Images: One Plus 6, facing back camera, China;
(2) Optical images: Olympus BXFM, Japan;
(3) Optical microscopy images: Olympus BXFM, Japan;
(4) Reflection Spectra: Probe-type spectrometer, Ocean Optics Maya 2000, US.

Following coating formulations are used in Examples and Comparative Examples:

Black Paint Formulation Comprises

(1) 100 parts by volume of Glasurit® 90-A926 Black Tinter (BASF Coatings GmbH),
(2) 40 parts by volume of Glasurit® 93-E3 Adjusting Base (BASF Coatings GmbH), and
(3) 5 parts by volume of Glasurit® 590-100 Basecoat Activator (BASF Coatings GmbH),

Clearcoat Formulation Comprises:

(1) 100 parts by volume of Glasurit® MS Clear 923-155 (BASF Coatings GmbH, a solution of hydroxyl-functional acrylic resin, having solid content of about 41% by weight or about 35% by volume),
(2) 50 parts by volume of Glasurit® MS 929-91 (BASF Coatings GmbH, a solution of polyisocyanate crosslinking agent, having solid content of about 45% by weight or about 38% by volume), and
(3) 15 parts by volume of Glasurit® 352-91 Reducer (BASF Coatings GmbH, a diluent),

Preparation of Silica Colloidal Particles (Modified Stoeber Method)

Arginine of 0.087 mg and water of 87 ml were mixed and stirred for 10 minutes at 25° C. After that tetraethylorthosilicate (TEOS, with a mass concentration of 98%, from Sinopharm Chemical Reagent Co. Ltd, China) of 5.55 ml was added and the obtained mixture was stirred at 70° C. for 24 hours. A solution of silica seeds was obtained containing particles having a size of around 20 nm as measured by TEM.

Aqueous ammonia (NH₃.H₂O, with a mass concentration of 28%) of 40 ml, ethanol (with a mass concentration of 99.9%) of 1000 ml and water of 1000 ml were mixed and stirred for 10 minutes at 25° C. The solution of silica seeds of 600 μL was added with stirring and then tetraethylorthosilicate (TEOS, 98%) of 80 ml was added. The obtained mixture was stirred at 70° C. for 24 hours. About 22 g monodisperse silica sphere particles having a size of 218 nm (shown in FIG. 1) was obtained after centrifugation and washing by ethanol for four times.

Monodisperse silica sphere particles having particle size of 190 nm, 192 nm, 242 nm and 251 nm were prepared according to the process described above by using the solution of silica seeds of 1000 μL, 990 μL, 450 μL and 400 μL respectively.

Preparation of Black Substrate

The black paint was applied onto a steel panel carrying a coating of cathodic electrophoresis CG800 (commercially available from BASF Coatings GmbH) by using a pneumatic spray gun (SATAjet® 5000-120 Digital, SATA GmbH & Co. KG, Germany, with nozzle diameter of 1.3 mm) with an air pressure of 0.35 MPa at a temperature of 2° C. and flashed-off at the same temperature for 3 minutes.

General Procedure of Preparing Structural Colored Coating Film

Monodisperse silica sphere particles were dispersed in a solvent to obtain a suspension of silica colloid particles. The suspension of silica colloid particles was sprayed onto a black substrate manually by using an airbrush (U-STAR S-120, available from U-STAR Model Tools Co. Ltd, Taiwan) under an air pressure of 0.17 MPa at a distance of 6 cm away from the substrate. The spray coating was carried out by moving the airbrush in a zigzag path as shown in FIG. 11 such that the coating layer on the substrate was continuous and homogenous. The coating layer was dried at a temperature of 90° C. for 10 mins to obtain a silica photonic crystal structure layer.

A clearcoat composition was sprayed onto the silica photonic crystal structure layer by an airbrush (U-STAR S-120, available from U-STAR Model Tools Co. Ltd, Taiwan) under an air pressure of 0.17 MPa, at a distance of 6 cm from the substrate. The spray coating was carried out by moving the airbrush in a zigzag path as shown in FIG. 11 to ensure the coating layer on the substrate was continuous and homogenous. The obtained coating was flashed-off at 24° C. for 5 minutes. The coated substrate was cured in a convection oven at 60° C. for 20 minutes to obtain the structural colored coating film.

Unless indicated otherwise, below Examples were using the above-mentioned general procedure.

### Example 1.1

15 parts by volume of monodisperse silica sphere particles having a particle size of 190 nm, 25 parts by volume of propylene carbonate and 60 parts by volume of ethanol was sprayed onto a horizontally placed black substrate having a size of 6 cm×7 cm. A photonic crystal structure layer was successfully formed on the substrate after drying that presents a good color effect and adhesion strength (shown in FIGS. 3 (a) and (a′)).

### Example 1.2

The process of Example 1.1 was repeated except that 25 parts by volume of glycerol and 60 parts by volume of ethanol was used for dispersing 15 parts by volume of monodisperse silica sphere particles. A photonic crystal structure layer was successfully formed on the substrate that presents an acceptable color effect and adhesion strength (shown in FIGS. 3 (b) and (b′)).

### Example 1.3

The process of Example 1.1 was repeated except that 25 parts by volume of butanol and 60 parts by volume of ethanol was used for dispersing 15 parts by volume of monodisperse silica sphere particles. A photonic crystal structure layer was successfully formed on the substrate that presents a good color effect and adhesion strength (shown in FIGS. 3 (c) and (c′)).

### Example 1.4

The process of Example 1.1 was repeated except that 25 parts by volume of 1,5-pentanediol and 60 parts by volume of ethanol was used for dispersing 15 parts by volume of monodisperse silica sphere particles. A photonic crystal structure layer was formed on the substrate that presents an acceptable color effect and adhesion strength (shown in FIGS. 3 (d) and (d′)).

### Comparative Example 1.1

15 parts by volume of monodisperse silica sphere particles having a particle size of 190 nm were dispersed in a solvent of 85 parts by volume of propylene carbonate to obtain a suspension of silica colloid particles. The suspension was sprayed onto a horizontally placed black substrate having a size of 6 cm×7 cm and the coated substrate was dried. A photonic crystal structure layer with good saturation of color was formed on the substrate that is easily peeled off from the substrate (shown in FIG. 2).

The parts by volume of the silica sphere particles were calculated via dividing the mass of monodisperse silica sphere particles by the density of 2.04 g/ml that was described in P. Jiang et al, Single-Crystal Colloidal Multilayers of Controlled Thickness, Chem. Mater. 1999, 11, 2132-2140.

### Comparative Example 1.2

The process of Comparative Example 1.1 was repeated except that 85 parts by volume of ethanol was used for dispersing 15 parts by volume of monodisperse silica sphere particles. A photonic crystal structure layer with cracks was obtained (shown in FIG. 2).

### Comparative Example 1.3

The process of Comparative Example 1.1 was repeated except that 85 parts by volume of ethylene glycol was used for dispersing 15 parts by volume of monodisperse silica sphere particles. The photonic crystal structure layer is easily peeled off from the substrate and showed serious shrinkage (shown in FIG. 2).

It has been found that the photonic crystal structure layer with defects were obtained when propylene carbonate, ethanol and ethylene glycol was used alone as the solvent.

### Comparative Example 1.4

The process of Example 1.1 was repeated except that 25 parts by volume of ethylene glycol and 60 parts by volume of ethanol was used for dispersing 15 parts by volume of monodisperse silica sphere particles. A photonic crystal structure layer having quite poor color effect was obtained as shown in FIGS. 3 (e) and (e′).

It has been surprisingly found that a photonic crystal structure layer with a good color effect and sufficient adhesion strength to the substrate are successfully formed when a mixture solvent comprising ethanol and at least one selected from a group consisting of propylene carbonate, glycerol, n-butanol and 1,5-pentanediol was used for dispersing monodisperse silica sphere particles. As a contrast, when a mixture solvent of ethanol and ethylene glycol was used, a photonic crystal structure layer was obtained with unacceptable defects.

### Example 2.1

15 parts by volume of monodisperse silica sphere particles having a particle size of 190 nm were dispersed in a solvent mixture of 42.5 parts by volume of propylene carbonate and 42.5 parts by volume of ethanol to obtain a suspension of silica colloid particles. The suspension of silica colloid particles was sprayed onto a horizontally placed black substrate having a size of 6 cm×7 cm and the coated substrate was dried.

A photonic crystal structure layer having a good color effect and adhesion strength was formed on the substrate (shown in FIGS. 4 (b), (b′) and (e)).

### Example 2.2

The process of Example 2.1 was repeated except that a solvent mixture of 40 parts by volume of propylene carbonate and 40 parts by volume of ethanol was used for dispersing 20 parts by volume of monodisperse silica sphere particles. A photonic crystal structure layer having a good color effect and adhesion strength was formed on the substrate (shown in FIGS. 4 (c), (c′) and (e)).

### Comparative Example 2.1

10 parts by volume of monodisperse silica sphere particles having a particle size of 190 nm were dispersed in a solvent mixture of 45 parts by volume of propylene carbonate and 45 parts by volume of ethanol to obtain a suspension of silica colloid particles. The suspension of silica colloid particles was sprayed onto a horizontally placed black substrate having a size of 6 cm×7 cm. A photonic crystal structure layer was formed in the unsprayed region of the substrate as well (shown in FIGS. 4 (a), (a′) and (e)).

### Comparative Example 2.2

The process of Comparative Example 2.1 was repeated except that a solvent mixture of 37.5 parts by volume of propylene carbonate and 37.5 parts by volume of ethanol was used for dispersing 25 parts by volume of monodisperse silica sphere particles. The photonic crystal structure layer showed a poor color effect due to inadequate assembly of particles (shown in FIGS. 4 (d), (d′) and (e)).

### Example 3

The process of Example 1.1 was repeated except that suspensions (a), (b) and (c) of monodisperse silica sphere particles having a particle size of 251 nm was respectively sprayed onto vertically placed black substrates to obtain photonic crystal structure layers. After that, clearcoat composition was applied onto the photonic crystal structure layers to obtain the structural colored coating films. Thus, three specimens were prepared.

Suspension (a): a suspension containing 15 parts by volume of monodisperse silica sphere particles and a solvent mixture of 42.5 parts by volume of propylene carbonate and 42.5 parts by volume of ethanol.

Suspension (b): a suspension containing 18 parts by volume of monodisperse silica sphere particles and a solvent mixture of 41 parts by volume of propylene carbonate and 41 parts by volume of ethanol.

Suspension (c): a suspension containing 20 parts by volume of monodisperse silica sphere particles and a solvent mixture of 40 parts by volume of propylene carbonate and 40 parts by volume of ethanol.

As shown in FIGS. 5 (a) to (d), a red coating film was successfully formed on the substrate having a good color effect and adhesion strength in each case. And the coating film showed the most homogeneous and saturated color when the volume ratio of monodisperse silica sphere particles is 18% based on the total volume of the suspension.

### Example 4

18 parts by volume of monodisperse silica sphere particles having a particle size of 251 nm were dispersed in solvent mixtures of propylene carbonate and ethanol in amounts described in Table 1 to obtain a series of suspensions of silica colloid particles. After that, those suspensions were sprayed onto vertically placed black substrates having a size of 6 cm×7 cm and the coated substrates are dried. As shown in FIGS. 6 (a) to (d), the obtained photonic crystal structure layers No. 4.1 to 4.4 (from left to right) have good color effects.

The clearcoat composition was applied onto the photonic crystal structure layers to obtain the structural colored coating films. A red coating film was formed on each substrate presenting a good color effect and adhesion strength (shown in FIGS. 6 (a′) to (d′)). And the structural colored coating film showed the most saturated and homogenous color when the volume ratio of propylene carbonate and ethanol is 1:1 (shown in FIG. 6 (c′)).

TABLE 1

| Solvent | No. 4.1 | No. 4.2 | No. 4.3 | No. 4.4 |
|---|---|---|---|---|
| Propylene carbonate | 10 | 20 | 41 | 55 |
| (parts by volume) | | | | |
| Ethanol | 72 | 62 | 41 | 27 |
| (parts by volume) | | | | |

### Example 5

18 parts by volume of monodisperse silica sphere particles having particle sizes of 251 nm, 242 nm, 218 nm and 192 nm respectively were dispersed in a solvent mixture of 41 parts by volume of propylene carbonate and 41 parts by volume of ethanol to obtain a series of suspensions of silica colloid particles. After that, those suspensions were sprayed onto vertically placed black substrates having a size of 6 cm×7 cm and the coated substrates are dried. The clearcoat composition was applied onto the photonic crystal structure layers to obtain the structural colored coating films.

As shown in the FIG. 7(a), coating films obtained by using silica particles having sizes of 251 nm, 242 nm, 218 nm and 192 nm respectively present colors of red, yellow, green and blue. Their optical microscopy images, SEM images and reflection spectra as shown in FIGS. 7(b) to (d). Thus, as one approach, the structural color effects are adjusted by particle sizes of silica particles.

### Example 6

18 parts by volume of monodisperse silica sphere particles having a particle size of 251 nm were dispersed in a solvent mixture of 41 parts by volume of propylene carbonate and 41 parts by volume of ethanol to obtain suspension (1) of silica colloid particles. Suspension (1) was sprayed onto a horizontally placed black substrate having a size of 6 cm×7 cm with an airbrush (U-STAR S-120, available from U-STAR Model Tools Co. Ltd, Taiwan) under an air pressure of 0.17 MPa at a distance of 6 cm away from the substrate, and the coated substrate was dried at 25° C.

Subsequently, 18 parts by volume of monodisperse silica sphere particles having a silica particle size of 192 nm were dispersed in a solvent mixture of 41 parts by volume of propylene carbonate and 41 parts by volume of ethanol to obtain suspension (2) of silica colloid particles. Suspension (2) was sprayed onto the substrate under the same conditions of suspension (1).

The spray coating was carried out by moving the airbrush in a zigzag path as shown in FIG. 11 such that the coating layer on the substrate was continuous and homogenous. The coated substrate was dried at a temperature of 90° C. for 10 minutes and further coated by a clearcoat composition to obtain the structural colored coating films.

As shown in FIGS. 8(a) to (c), a purple coating film was obtained. The “purple” effect comes from the combination of underneath red photonic crystal structure layer and above blue photonic crystal structure layer.

### Example 7

18 parts by volume of monodisperse silica sphere particles having a particle size of 218 nm were dispersed in a solvent mixture of 41 parts by volume of propylene carbonate and 41 parts by volume of ethanol to obtain a suspension of silica colloid particles. And a black substrate in a size of 21 cm×29.7 cm was prepared having a black coating in a thickness of 25 μm. The suspension was sprayed onto the vertically placed black substrate by using a spray gun (SATAjet® 5000-120 Digital, SATA GmbH & Co. KG, Germany, with nozzle diameter of 1.3 mm) under an air pressure of 0.35 MPa at a distance of 14 cm away from the substrate. The spray coating was carried out by moving the airbrush in a zigzag path as shown in FIG. 11 such that the coating layer on the substrate was continuous and homogenous. The coated substrate was dried at a temperature of 90° C. for 10 mins to obtain a silica photonic crystal structure layer.

A clearcoat composition was sprayed onto the silica photonic crystal structure layer by using a spray gun (SATAjet® 5000-120 Digital, SATA GmbH & Co. KG, Germany, with nozzle diameter of 1.3 mm) under an air pressure of 0.35 MPa at a distance of 14 cm away from the substrate. The spray coating was carried out by moving the airbrush in zigzag path as shown in FIG. 11 such that the coating layer on the substrate was continuous and homogenous. The obtained coating was flashed-off at 24° C. for 5 minutes. The coated substrate was dried in a convection oven at 60° C. for 20 minutes to obtain the structural colored coating film.

As shown in FIGS. 9(a) and (b), the obtained coating film showed highly saturated color.

The homogeneity of the coating film was tested by measuring thickness of the coating film via a magnetic thickness meter Aicevoos AS-X6 (commercially available from Wuhan Zhongce Hongtu Measuring Instrument Co., Ltd., China) at 9 different points within an area of 5 cm×8 cm (shown in FIG. 9 (a)).

The thickness measurement results were shown in Table 2.

TABLE 2

| | | Calculated thickness |
|---|---|---|
| | Total thickness | of photonic crystal |
| | of coating film* | coating film |
| Points | [μm] | [μm] |
| 1 | 46.7 | 21.7 |
| 2 | 46.7 | 21.7 |
| 3 | 49.3 | 24.3 |
| 4 | 46.1 | 21.1 |
| 5 | 51 | 26 |
| 6 | 49.2 | 24.2 |
| 7 | 49.7 | 24.7 |
| 8 | 46.4 | 21.4 |
| 9 | 51.6 | 26.6 |
| Ave. | 48.5 | 23.5 |
| Std. Dev. | 2.1% | 2.1% |

*Total thickness of coating films = the thickness of black coating on black substrates + the thickness of the photonic crystal coating film

The photonic crystal coating film has an average thickness of 23.5 μm with a standard deviation of 2.1%, which denotes a relatively homogenous photonic crystal coating film was obtained.

### Example 8

A stereo automobile model in a size of 18 cm×8 cm×6 cm was used to simulate the process of coating an automobile body. The model was coated with black paint by a pneumatic paint sprayer (SATAjet® 5000-120 Digital, SATA GmbH & Co. KG, Germany, with nozzle diameter of 1.3 mm) under an air pressure of 0.35 MPa at a temperature of about 24° C. and then flashed-off at the same temperature for 3 minutes to obtain a black stereo substrate.

18 parts by volume of monodisperse silica sphere particles having a particle size of 218 nm in a solvent mixture of 41 parts by volume of propylene carbonate and 41 parts by volume of ethanol to obtain a suspension of silica colloid particles. The suspension was sprayed onto the black stereo substrate by using a spray gun (SATAjet® 5000-120 Digital, SATA GmbH & Co. KG, Germany, with nozzle diameter of 1.3 mm) under an air pressure of 0.35 MPa at a distance of 14 cm away from the substrate in a zigzag path described in Example 7 and dried at a temperature of 60° C. to obtain a silica photonic crystal structure layer.

A clearcoat composition was sprayed onto the silica photonic crystal structure layer via a spray gun (SATAjet® 5000-120 Digital, SATA GmbH & Co. KG, Germany, with nozzle diameter of 1.3 mm) under an air pressure of 0.35 MPa at a distance of 14 cm away from the substrate in a zigzag path described in Example 7. The obtained coating layer was flashed-off at 24° C. for 5 minutes. The coated substrate was dried in a convection oven at 60° C. for 20 minutes to obtain the structural colored coating film.

As shown in FIG. 10(a), a coating film having yellow green color from top view and green blue color from side view was formed showing good color saturation.

### Example 9

The process of Example 8 was repeated except that a suspension of silica sphere particles with particle size of 251 nm was used. As shown in FIG. 10(b), a coating film having red color from top view and green color from side view was formed showing good color saturation.

1. A process of preparing a structural colored coating film comprising steps of
i). applying colloidal particles dispersed in a solvent mixture comprising at least two organic solvents onto a substrate to form a colloidal particles layer;
ii). drying the colloidal particles layer to form a photonic crystal structure layer;
iii). applying a coating composition comprising at least one thermally crosslinkable resin and at least one crosslinking agent onto the photonic crystal structure layer to form a coating; and
iv). heat curing.

2. The process according to claim 1, wherein the solvent mixture comprises at least one solvent having a high boiling point and at least one solvent having a low boiling point.

3. The process according to claim 2, wherein the solvent having a high boiling point is at least one selected from the group consisting of glycerol, n-butanol, 1,5-pentanediol, and propylene carbonate.

4. The process according to claim 2, wherein the solvent having a low boiling point is at least one selected from the group consisting of ethanol, acetone, and isopropanol.

5. The process according to claim 3, wherein the solvent mixture comprises ethanol and at least one selected from the group consisting of glycerol, n-butanol, 1,5-pentanediol, and propylene carbonate.

6. The process according to claim 2, wherein the ratio by volume between the solvent having a high boiling point and the solvent having a low boiling point is from 1:10 to 10:1.

7. The process according to claim 2, wherein the volume ratio of the colloidal particles is from 10% to 25% based on the total volume of the suspension of colloidal particles.

8. The process according to claim 1, wherein it further comprises a step of forming at least one further photonic crystal structure layer before a step of applying a coating composition comprising at least one thermally crosslinkable resin and at least one crosslinking agent.

9. The process according to claim 1, wherein the thermally crosslinkable resin is at least one selected from the group consisting of resins functionalized by carboxyl, hydroxyl, vinyl, epoxy, and silanol groups.

10. The process according to claim 9, wherein the thermally crosslinkable resin is at least one selected from the group consisting of acrylic resins, polyester resins, alkyd resins, urethane resins, epoxy resins, and fluororesins.

11. The process according to claim 1, wherein the crosslinking agent is at least one selected from the group consisting of polyisocyanate compounds, blocked polyisocyanate compounds, melamine resins, urea resins, carboxy-functional compounds, carboxy-functional resins, vinyl-functional resins, vinyl-functional compounds, epoxy-functional resins, and epoxy-functional compounds.

12. The process according to claim 1, wherein the combination of the thermally crosslinkable resin and the crosslinking agent is at least one selected from the group consisting of a combination of carboxy-functional resin and epoxy-functional resin, a combination of hydroxy-functional resin and polyisocyanate compound, a combination of hydroxy-functional resin and blocked polyisocyanate compound, a combination of hydroxy-functional resin, and melamine resin.

13. An article having at least one structural colored coating film obtainable or obtained from the process according to claim 1.

14. A method of using the article according to claim 13, the method comprising using the article in automobile bodies as exterior panel or other parts.

15. The process according to claim 2, wherein the ratio by volume between the solvent having a high boiling point and the solvent having a low boiling point is from 1:3 to 3:1.

16. The process according to claim 2, wherein the ratio by volume between the solvent having a high boiling point and the solvent having a low boiling point is from 2:3 to 3:2.

17. The process according to claim 2, wherein the volume ratio of the colloidal particles is from 12% to 23% based on the total volume of the suspension of colloidal particles.

18. The process according to claim 2, wherein the volume ratio of the colloidal particles is from 15% to 20% based on the total volume of the suspension of colloidal particles.
